(19) United States
(12) Patent Application Publication
(10) Pub. No.: US 2003/0093510 A1
(43) Pub. Date: May 15, 2003

(54) Method and apparatus for enumeration of a multi-node computer system

(76) Inventor: Ling Cen, Austin, TX (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/992,725

(22) Filed: Nov. 14, 2001

(51) Int. Cl. G06F 15/173; G06F 15/16

(52) U.S. Cl. 709/223; 709/203

(57) ABSTRACT

A method and apparatus for enumeration of a multi-node computer system. A local bootstrap processor is selected using a local boot flag register from a group of local node processors. The local bootstrap processor is responsible for enumerating the local node elements. A global bootstrap processor is selected using a global boot flag register to be responsible for enumerating the components of the system. A server management device monitors enumeration progress.

### FIELD OF THE INVENTION

The present invention pertains to the field of initializing a complex computer system. More particularly, it relates to a method and apparatus used to enumerate a complex multi-node computer system in an efficient manner.

### BACKGROUND OF THE RELATED ART

Reliable High Availability (HA) systems are designed to minimize service disruptions, achieve maximum uptime, and reduce the potential for unplanned outages. HA systems may be used to facilitate critical services such as emergency call centers and stock trading, as well as services for military applications. HA systems are typically benchmarked against reliability, serviceability, and availability (RAS) requirements. RAS capabilities typically require that a HA system is up and running more than 99.999% of the time.

Servers, which may be complex computer systems, provide critical services that may require RAS capabilities. Servers that achieve maximum uptime are generally designed with redundancy so that there is no single point of failure in the system. If a specific system component performing a task malfunctions, another system component is available to complete the task. Independent groups of system elements, which often have similar functionality, are generally referred to as nodes. Reliability may be directly correlated with the amount of redundancy a system employs. Therefore, a system with more nodes to perform a specific function may be more reliable.

When a complex system shuts down due to malfunction or planned servicing, downtime may be minimized if the system start-up procedure is efficient and may initialize the many nodes of the system in a short amount of time. The start-up procedure, also called a boot process, typically includes an enumeration process to identify the system resources and verify that the resources are functioning properly. The present invention includes a method and apparatus for an efficient enumeration process. By delegating a portion of the enumeration tasks to processors residing locally in the nodes and performing a portion of the enumeration tasks in parallel, the invention achieves a significant reduction of start-up time.

### BRIEF DESCRIPTION OF THE DRAWINGS

FIG. 1A illustrates one embodiment of a multi-node system.

FIG. 1B shows a flow diagram for one embodiment of enumerating a multi-node system.

FIG. 2 illustrates one embodiment of a node.

FIG. 3A shows a flow diagram for one embodiment of booting a node.

FIG. 3B shows a flow diagram of one embodiment for node element enumeration.

FIG. 4 shows a detailed embodiment of a multi-node switched system.

FIG. 5 illustrates a flow diagram for one detailed embodiment of enumerating a multi-node system.

FIG. 6A illustrates one embodiment of a multi-node system with a server management device.

FIG. 6B illustrates a flow diagram for one embodiment of monitoring node enumeration with a server management device.

FIG. 7 shows one embodiment of a HA multi-node system.

FIG. 8 illustrates a flow diagram of one embodiment of monitoring system enumeration with a server management device.

### DETAILED DESCRIPTION OF THE INVENTION

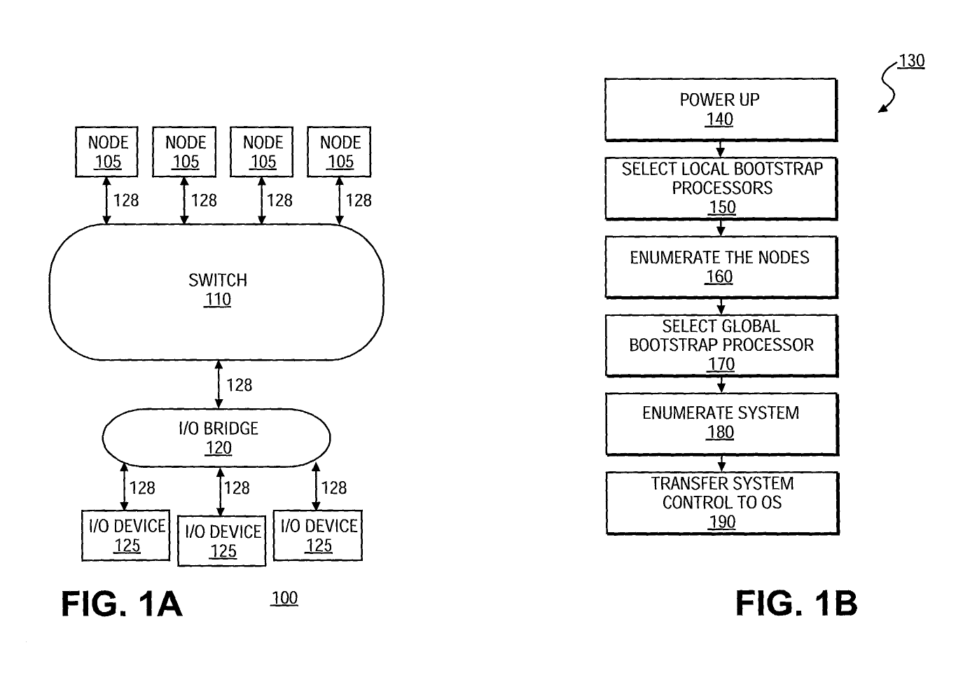

FIG. 1A illustrates one embodiment of a multi-node system 100 to practice the invention. The multi-node system 100 includes four independent nodes 105. In actual practice, the number of nodes 105 may vary and may not be limited to just four. In one embodiment, a given node 105 may be an independent group of system elements that may include at least one processor. One or more nodes 105 may be directly interfaced to a switch 110 with an interface line 128. The switch 110 may be programmed to send packets to specific system components based on component specific identifications or addresses. Examples of system components may be the individual nodes 105, the switch 110, an input/output (I/O) bridge 120, and one or more I/O devices 125. The switch 110 facilitates inter-node communications as well as communications between nodes 105 and the I/O bridge 120. The I/O bridge 120 may be connected directly to the switch 110 and I/O devices 125 with interface lines 128. The interface lines 128 may also be a bus. The I/O bridge 120 provides the system with access to the I/O devices 125. Examples of I/O devices 125 include printers, disk drives, and network connections to other systems such as local area network (LAN) connections. The nodes 105 may be capable of communicating with the I/O devices 125 by sending and receiving information through the switch 110 which routes the information to the I/O bridge 120 via the interface lines 128.

In one embodiment, the I/O bridge 120 is part of a Southbridge which is used in certain Intel® (Intel® Corporation, Santa Clara, Calif.) architectures for personal computers. The Southbridge includes most basic forms of I/O interfacing, including the universal serial bus (USB), serial ports, and audio. In another embodiment, the I/O bridge 120 may be part of the I/O controller hub which includes a peripheral component interface (PCI) and is part of the Intel® Hub Architecture (IHA).

FIG. 1B shows an exemplary flow diagram 130 to enumerate a multi-node system, such as the system 100 of FIG. 1A. Enumeration is typically the process of identifying resources, testing resources to verify functionality, and generating an enumeration list with information about the resources. After the system is powered up (block 140), a local bootstrap processor is selected for the individual nodes (block 150). In one embodiment, the local bootstrap processor may be responsible for identifying and testing the resources local to the node. The local node resources, referred to as local elements, may include processors and memory devices. After selecting the local bootstrap processor for the nodes (block 150), the individual nodes are enumerated by their respective local bootstrap processors (block 160). Following node enumeration (block 160), a global bootstrap processor may be selected (block 170). In one embodiment, the global bootstrap processor may be responsible for enumerating all system components. Examples of system components are nodes, switches, and I/O bridges. Next, the global bootstrap processor enumerates the components of the whole system (block 180). After the entire system is enumerated (block 180), control of the system is transferred to the operating system (OS) (block 190). The OS may efficiently manage and assign tasks to the system resources based on information provided in the enumeration list.

In one embodiment, the flow 130 may be used to significantly decrease system boot time by independently enumerating the nodes (block 160) in parallel during the same time frame. A parallel node enumeration scheme for N nodes may be completed in approximately the amount of time it takes to enumerate a single node, T seconds. A serial node enumeration scheme for N nodes which performs node enumeration node by node, one after the other, may be completed in approximately N*T seconds. Complex multi-node systems may have many nodes, and a parallel enumeration scheme significantly improves boot performance. For example, a system using a parallel node enumeration scheme with 50 nodes may complete node enumeration fifty times faster than if using a serial node enumeration scheme. Furthermore, because a local bootstrap processor may be selected for the individual node, there is no time wasted on arbitrating between nodes to select a single bootstrap processor for enumerating all the nodes.

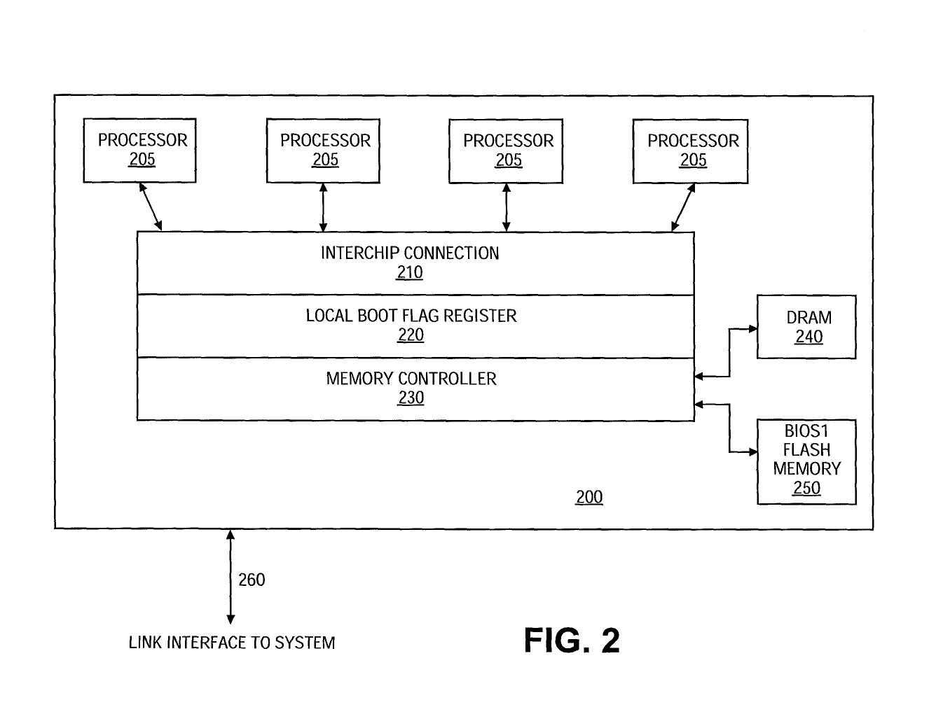

FIG. 2 illustrates one embodiment of a multi-processor node 200 to practice the invention. Node 200 has four local processors 205. A node may have any number of elements, and a processor node may have any number of processors 205. The processors in the multi-processor node 200 may be coupled with an interchip connection 210. The interchip connection 210 provides an interface between the processors 205 to allow the processors to communicate. In one embodiment, a separate interface may be used to allow the processors 205 to communicate with other elements of the node 200. The memory controller 230 coupled to the interchip connection 210 is one example of an interface that allows the processors 205 to communicate with other elements, such as local node memory.

In one embodiment, the interchip connection 210 may be a front side bus (FSB) and the memory controller 230 may be a Northbridge controller which both are used in certain Intel® architectures for personal computers. The Northbridge communicates with processors over the FSB and acts as the controller for memory, the accelerated graphics port (AGP) and the PCI. In another embodiment, the interchip connection 210 and the memory controller 230 may be part of IHA. The IHA includes a FSB and a Graphics and AGP Memory Controller Hub, which is similar to the Northbridge, but is capable of higher bus speeds and does not include a PCI interface.

One embodiment of local node memory coupled to the memory controller 230 may be dynamic random access memory (DRAM) 240. Another local node element that may be accessed through the memory controller 230 is the basic input/output system software (BIOS) 1 stored in the flash memory 250. The BIOS 1 flash memory 250 includes software for enumerating the node 200 and is coupled to the memory controller 230. In one embodiment, the BIOS 1 flash memory 250 may not include the software required for enumerating the whole system. In another embodiment, the BIOS 1 software may be stored in a read only memory (ROM). The node 200 may include all the elements required to enumerate the node 200.

The node 200 includes a local boot flag register 220 that may be accessed by the local node processors 205. In one embodiment, the local boot flag register 220 may be coupled to the interchip connection 210. The local boot flag register 220 may be coupled to the memory controller 230. The local boot flag register 220 may be used to determine which of the processors 205 in the node 200 may be the local bootstrap processor responsible for enumerating the node 200. The local boot flag register 220 may be a register that by default is in a zero state and remains in a zero state until after it has been accessed or read the first time.

After the local boot flag register 220 has been read one time, the local boot flag register may be in a non-zero state for all subsequent reads unless the local boot flag register 220 is reset. Therefore, an efficient scheme to select a local bootstrap processor from multiple processors 205 in a node 200 may be to have the individual processors 205 read the local boot flag register 220 and identify the local bootstrap processor as the processor 205 which reads a zero state from the local boot flag register 220. This scheme avoids any lengthy arbitration between node processors 205 to determine which is the local bootstrap processor. It should be appreciated by one skilled in the art that the number of accesses, including reads and writes, required to change the state of the local boot flag register 230, as well as the specific state to trigger selecting the local bootstrap processor may take on many combinations within the scope of the present invention.

In another embodiment, the node 200 may include a local counter instead of the local boot flag register 220. When a processor 205 reads the counter, the count increases. The local bootstrap processor may be the processor 205 that reads a specific count from the local counter. It should be apparent to one skilled in the art that there are many devices, specific logic levels, and accesses such as reads, writes, and interrupts, that may be used to select one processor 205 as the local bootstrap processor.

The node 200 may be one of many components in a larger system. The link interface 260 provides an interface between the node 200 and other components of the system. The link interface 260 may be disabled upon power up of the node 200. If the link interface 260 between the node 200 and all other components of the system is disabled upon power up, the node 200 may remain isolated from the rest of the larger system until the link interface 260 is enabled. The link interface 260 may be enabled once the processor node is successfully enumerated. Therefore, the node 200 may only be interfaced to other components if it is functioning properly. Successful enumeration may be the completion of identifying, testing, and listing the resources in an enumeration list, which requires a basic level of functionality.

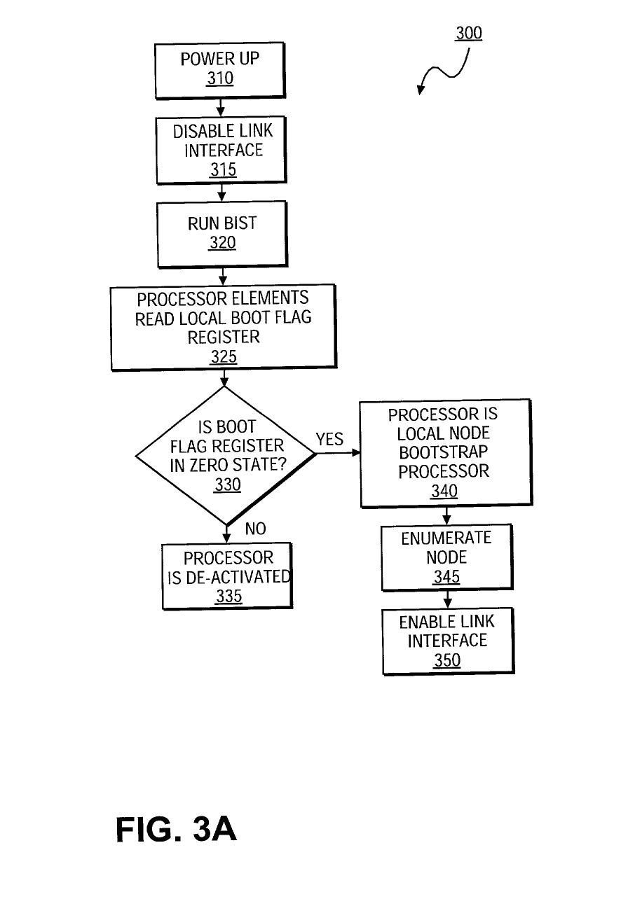

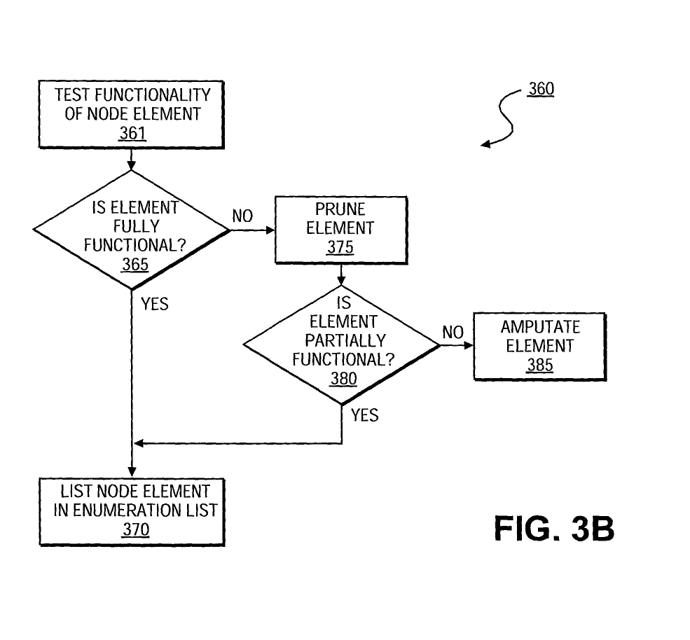

FIG. 3A shows a flow diagram 300 for one embodiment of booting a node. After power up (block 310), the link interface for the node is disabled (block 315). In the embodiment shown, the link interface may be controlled by accessing a register. For example, after power up (block 310), the link interface may be disabled (block 315) by writing to a link interface control register. In another embodiment, the link interface may be disabled by default after power up (block 310) and no action may be required to disable the link interface (block 315). After the link interface for the node is disabled (block 315), individual elements of the node run a built-in-self-test (BIST) (block 320). In one embodiment, the BIST is a rudimentary set of tests to verify basic functionality. Typically, the BIST is a self-contained test that may not require accessing information outside of the node element itself and may not require any interaction between local node elements. After running the BIST (block 320), the processor elements in the node read the local boot flag register (block 325). In one example, the local boot flag register may be in a zero state until it is read the first time and remains in a nonzero state after being read the first time, unless it is reset. Therefore the first node processor which reads from the local boot flag register may read a zero state and know that it should become the local node bootstrap processor.

After the processors read the local boot flag register (block 325), the processors determines if the local boot flag register is in a zero state (block 330). If a processor is the first to read the local boot flag register (block 325) and determines that the local boot flag register is in a zero state (block 330), then that processor is the local node bootstrap processor (block 340). If the processor determines that the local boot flag register is not in a zero state (block 330), then the processor is deactivated (block 335). In one embodiment, the processor may be de-activated (block 335) by entering a hibernation state. A hibernation state is a low power state. In another embodiment, the processor may be de-activated (block 335) by entering a waiting loop. Next, the local node bootstrap processor enumerates the node (block 345). In one embodiment, the local node bootstrap processor may perform a full suite of functionality tests on all the elements in the node. After enumerating the node (block 345), the local node bootstrap processor enables the link interface (block 350). Those skilled in the art would know that there are many methods to select a local bootstrap processor from a group of local node processors.

FIG. 3B shows a flow diagram 360 of one embodiment for node element enumeration. First, the local node bootstrap processor tests the functionality of a node element (block 361). For example, a full suite of functionality tests may be performed on a memory element analyzing the memory sectors in the memory element. Additionally, the interaction of the memory with a memory controller and other devices may be also be tested. Then a determination is made on whether or not the element is fully functional (block 365). If the element is fully functional, then the node element is listed in the enumeration list as fully functional (block 370).

In one embodiment, the enumeration list may be stored in a flash memory device such as the BIOS 1 flash memory 250 of FIG. 1. If the element is not fully functional, the element is pruned (block 375) by the local node bootstrap processor. Pruning is a process to salvage working portions of a malfunctioning node element or system component. For example, if a node element is a memory device and the memory device has 30% of the memory sectors malfunctioning and 70% of the memory sectors functioning properly, the local node bootstrap processor may determine that the memory device is still useful and identify the working sector addresses. If during pruning of the element (block 375) the local node bootstrap processor determines that the element is partially functional (block 380), then it may include the partially functioning element in the enumeration list (block 370).

If the local node bootstrap processor determines that the element is not partially functional (block 380), the element is amputated from the node (block 385). Amputation is the disabling of an element of a node, or a component of a system, so that it is no longer accessible. In one embodiment, amputated node elements may not be listed in the enumeration list. In another embodiment, amputated elements may be listed in the enumeration list and marked to indicate improper functionality.

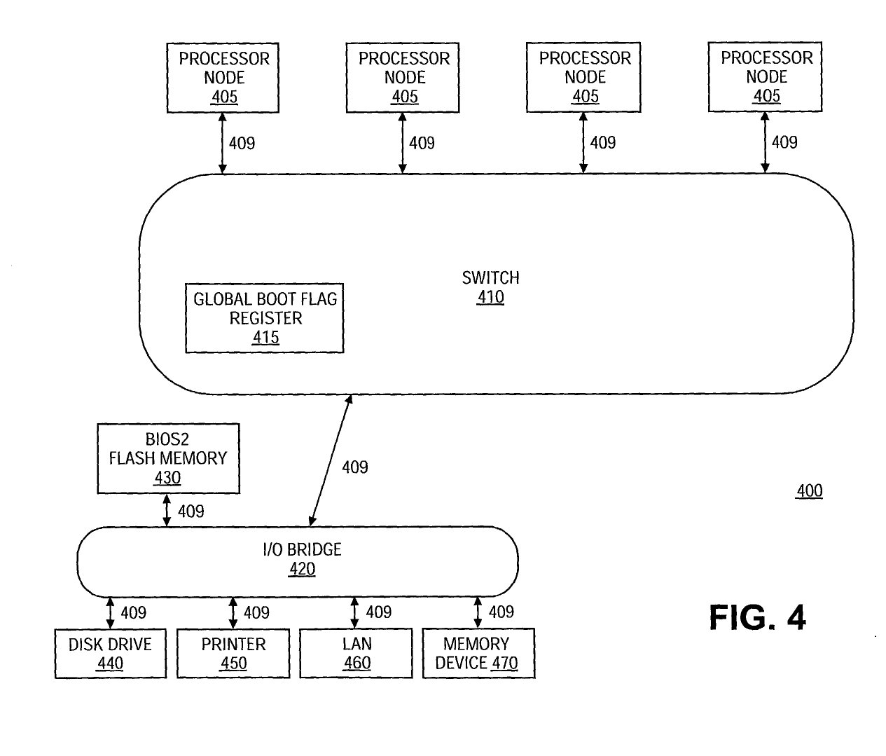

FIG. 4 shows a detailed illustration of another multi-node switched system 400. The switched system 400 includes four processor nodes 405, although a multi-node switched system may have any number of processor nodes 405. In one embodiment, the processor nodes 405 may be the processor node described in FIG. 2. The processor nodes 405 may be interfaced to a switch 410 through an individual link interface 409. The link interface 409 allows the processor nodes 405 to communicate with all the other components connected to the switch 410. An I/O bridge 420 provides an interface between all the components of the system 400 which may be linked to the switch 410 and various I/O devices linked directly to the I/O bridge 420 via link interfaces 409. Examples of devices linked directly to the I/O bridge 420 are a disk drive 440, a printer 450, a LAN connection 460, and a memory device 470. In one example, another device linked directly to the I/O bridge 420 may be a BIOS 2 flash memory 430. In one embodiment, the BIOS 2 flash memory includes software for enumerating the whole system 400. The link interface 409 between the switch 410 and the I/O bridge 420 may be enabled upon power up.

The switch 410 includes a global boot flag register 415. The global boot flag register 415 may be used to select the global bootstrap processor. The global bootstrap processor is responsible for enumerating the components of the system 400, such as the switch 410, the I/O bridge 420 and the nodes 405, whereas a local node bootstrap processor is responsible for enumerating the internal elements of a specific node 405. In one embodiment, the global boot flag register 415 may reside in the I/O bridge 420.

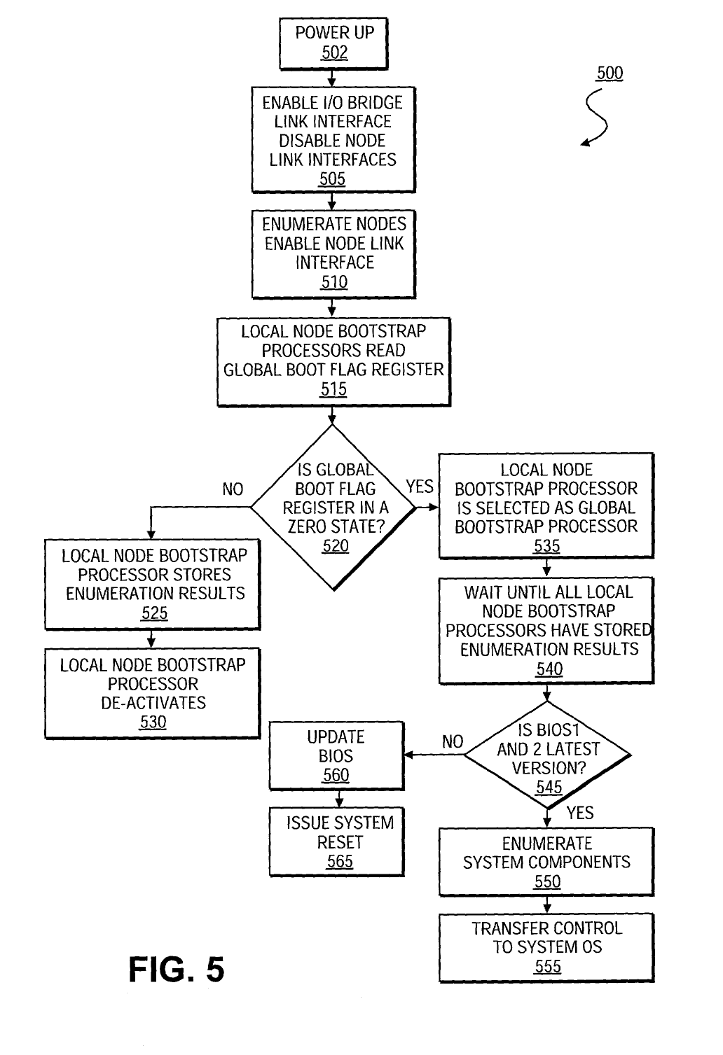

FIG. 5 illustrates a flow diagram for one detailed embodiment of enumerating a multi-node system. Upon power up (block 502), the link interface between any switch and any I/O bridge is enabled, and the link interface between any node and any switch is disabled (block 505). Next, individual nodes are enumerated and the link interface between the nodes may be enabled (block 510). The nodes may be enumerated using the method described in FIG. 3A and FIG. 3B. In one embodiment, if a node is not enumerated successfully, the node link interface remains disabled and the node is effectively amputated from the system. Once node enumeration is complete and the link interfaces are enabled (block 510), the local node bootstrap processors race to read the global boot flag register (block 515). If the local node bootstrap processor is the first to read the global boot flag register and determines that the global boot flag register is in a zero state (block 520), then the local node bootstrap processor is the global bootstrap processor (block 535). It should be apparent to one skilled in the art that there are many devices, specific logic levels, and accesses such as reads, writes, and interrupts, that may be used to select one processor as a bootstrap processor.

If the local node bootstrap processor is not the first to read the global boot flag register, and determines that the global boot flag register is not in a zero state (block 520), then the local node bootstrap processor stores the enumeration results for its local node (block 525). In one embodiment, the local node enumeration results may be stored in the BIOS 1 flash memory local to the node. In another embodiment, the local node enumeration results may be stored in the BIOS 2 flash memory that may be directly linked to the I/O bridge.

After storing the enumeration results (block 525), the local node bootstrap processor de-activates (block 530). In one embodiment, the local node bootstrap processor enters a waiting loop. In another embodiment, the local bootstrap processor enters a hibernation state. The global bootstrap processor waits for all the local node bootstrap processors to complete the enumeration of their respective nodes and store local enumeration results (block 540). If all the local node bootstrap processors have completed storing their enumeration results (block 530), the global bootstrap processor proceeds to check if the BIOS software is the latest revision (block 545). In one embodiment the global bootstrap processor checks the BIOS 1 software local to the nodes. In another embodiment, the global bootstrap processor checks the BIOS 2 software linked to the I/O bridge. In yet another embodiment, the global bootstrap processor checks both the BIOS 1 and BIOS 2 software. If the BIOS software is up to date, the global bootstrap processor enumerates the whole system (block 550). Once the system enumeration (block 550) is complete, control of the system is transferred from the global bootstrap processor to the OS (block 555). If the BIOS software is determined not to be the latest version (block 545), the BIOS software is updated (block 560), and the global bootstrap processor issues a system reset (block 565) to restart the entire boot process.

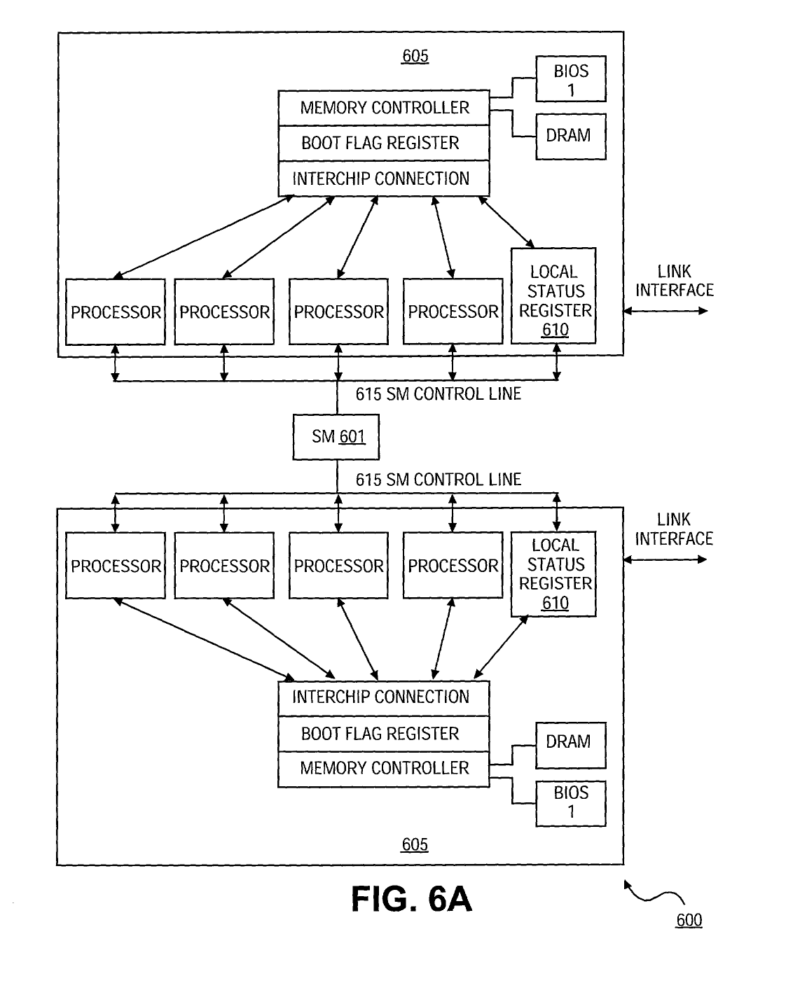

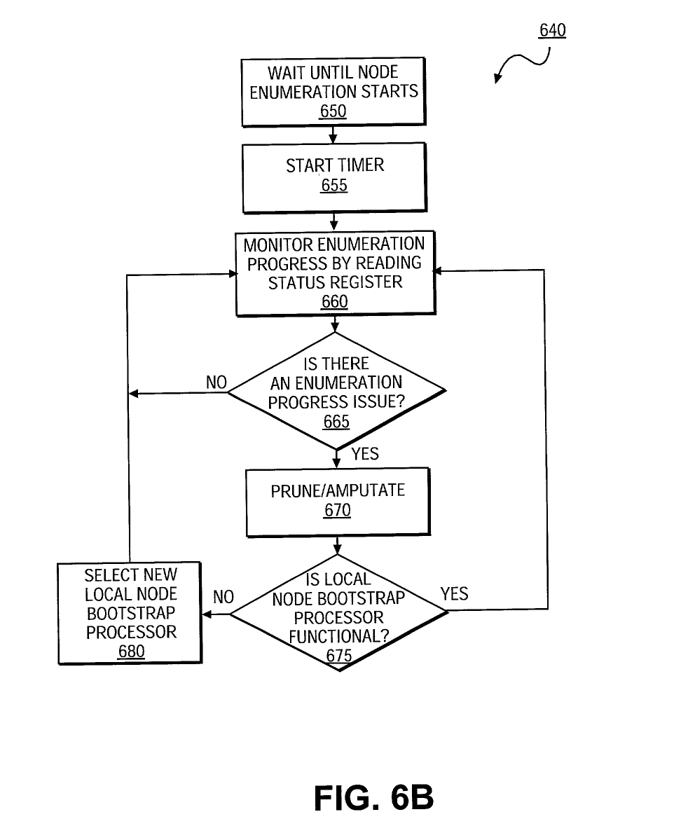

FIG. 6A illustrates another example of a multi-node system 600 with a server management (SM) device 601. In this embodiment, the SM device 601 may be a processor. The multi-node system 600 includes two multi-processor nodes 605. The nodes 605 may be identical to the node described in FIG. 2, with the exception of an additional local status register 610. Referring back to FIG. 2, the local status register 610 may be coupled to the interchip connection 210. In another embodiment, the local status register 610 may be coupled to the memory controller 230. The local status register 610 may be written to by the local node bootstrap processor after completing a task of the enumeration process. The SM device 601 may access the local status register 610 through the SM control line 615, which couples the SM device 601 to the nodes 605, and monitor the progress of node enumeration. If there is an issue with the progress of node enumeration, the SM device 601 may intervene in the enumeration process. For example, due to temperature changes during the boot process it may be possible for the local node bootstrap processor to begin enumeration and fail in the middle of enumeration.

The SM device 601 may determine that there is an enumeration progress issue caused by the local node bootstrap failing, such as the enumeration is not completed in a predetermined amount of time. While monitoring the progress of enumeration through the local status register 610, the SM device 601 may recognize an enumeration issue and either solve the issue or amputate the node. In one embodiment, the SM control line 615 allows the SM device 601 to access the elements of a node so that the SM device 601 may prune the node if there is an enumeration progress issue.

FIG. 6B illustrates a flow diagram for one embodiment of monitoring node enumeration with a SM device 640. The SM device waits until node enumeration starts (block 650). In one embodiment, the SM device may determine that node enumeration has started by reading the local status register. Once node enumeration has started, the SM device starts a timer (block 655). After starting the timer (block 655), the SM device monitors the progress of node enumeration by reading the local status register (block 660). After reading the local status register (block 660), the SM device determines if there is an enumeration progress issue (block 665). In one embodiment, the enumeration progress issue may be indicated by the local bootstrap processor in the local status register. In another embodiment, the SM device determines that there may be an enumeration progress issue based on how much time has passed between the start of an enumeration task and the completing of that task. For example, the SM device may have a predetermined list of time limits for successive tasks of node enumeration and a time limit for the whole node enumeration process. Using the timer as a time reference, the SM device may determine that there is an enumeration progress issue because a specific enumeration task has taken longer than a predetermined time limit.

If there is no enumeration progress issue (block 665), then the server management device continues monitoring the enumeration progress (block 660). If it is determined that there is a enumeration progress issue (block 665), the SM device performs pruning and/or amputation (block 670) on the node. In one embodiment, the SM device amputates elements of the node that were indicated through the local status register to be partially or fully malfunctioning. In another embodiment, the SM device amputates the whole node if there is an enumeration progress issue.

During pruning and amputation (block 670), a determination is made on whether or not the local node bootstrap processor is functional (block 675). If the enumeration progress issue is resolved as a result of the pruning/amputating (block 670) performed by the SM device, and the local node bootstrap processor is functional (block 675), the SM device continues to monitor enumeration progress (block 660). If the local node bootstrap processor is not functional, then a new local node bootstrap processor may be selected (block 680). In one embodiment, the new local node bootstrap processor may be selected by the SM device by amputating the old local node bootstrap processor and selecting one of the other node processors as the local node bootstrap processor. In another embodiment, the SM device may reset the local boot flag register of the node and may enable all the processors which have not been amputated to race to the local boot flag register in order to determine the new local bootstrap processor according to the flow described in FIG. 3A. If the enumeration progress issue is resolved as a result of selecting a new local node bootstrap processor (block 680), the SM device continues to monitor enumeration progress (block 660).

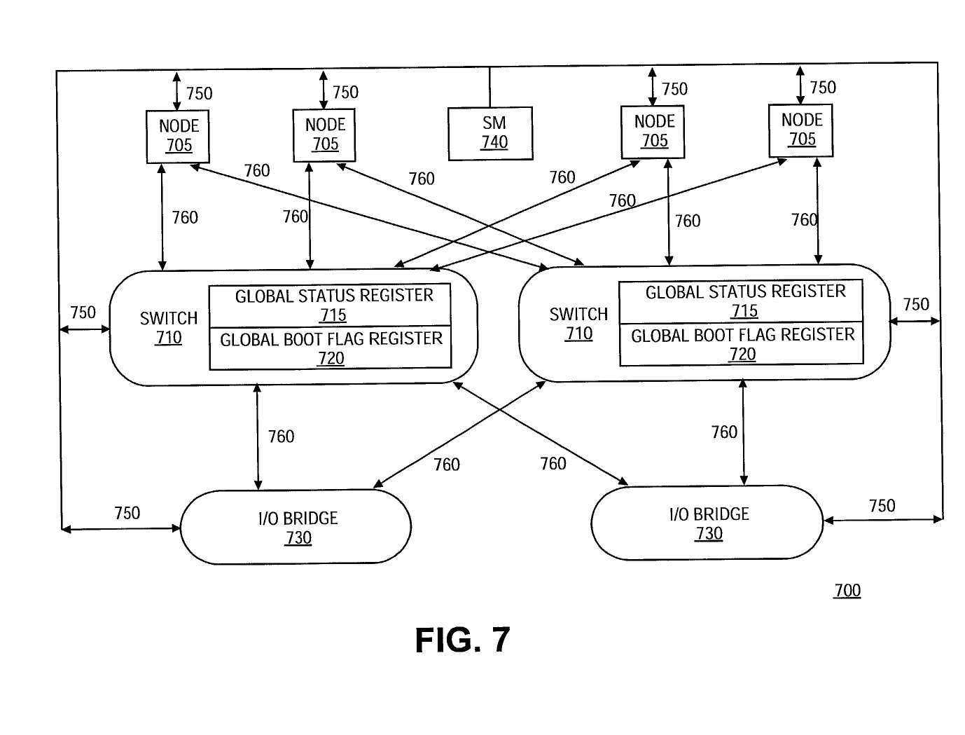

FIG. 7 shows one embodiment of a reliable HA multi-node system 700. The embodiment shown includes four nodes 705, two switches 710, and two I/O bridges 730. It is appreciated that the number of components or devices may vary depending on the design of the system. The nodes 705 and I/O bridges 730 are interfaced to the switches 710 with a link interface 760. A SM device 740 is coupled with the components of the system via a server management control line 750. In an alternate embodiment, The SM device may be coupled with a limited number of system components. The system 700 is reliable because it has no single point of failure. If any one component of the system fails there is at least one other component of the system that may perform the same functionality. The switches 710 include a global status register 715 and a global boot flag register 720. In one embodiment, the global status register 710 may be written to by the global bootstrap processor indicating the status of system enumeration.

In one embodiment, the system 700 goes through the process of node enumeration using the flow described in FIG. 3A and FIG. 3B including the SM node enumeration monitoring of FIG. 6B. Following the node enumeration process, the system 700 may go through the component enumeration process described in FIG. 5. Much like the SM control of the system in FIG. 6A, the system management device 740 may be used to monitor the progress of system component enumeration. In one embodiment, the server management device 740 monitors system enumeration progress through the global status register 715, which is written to by the global bootstrap processor throughout system enumeration. In the embodiment shown, the global status register 715 and the global boot flag register 720 reside in the switches 710. In another embodiment, the global status register 715 and the global boot flag register 720 may reside in the I/O bridges 730. In yet another embodiment, the global status register 715 and the global boot flag register 720 may reside separately in the switches 710 or the I/O bridges 730. The link interfaces 760 between the nodes 705 and switches 710 may be disabled, and the link interfaces 760 between the I/O bridges 730 and the switches 710 may be enabled upon power up.

All the switches 710 may be used simultaneously by default. Multiple switches 710 may simultaneously be used to route communications between system components by interleaving the communication tasks, which is a method of splitting up tasks and delegating some of the tasks to different switches 710. In another embodiment, one of the switches 710 may be used by default and all other switches 710 may be activated only when the default switch 710 fails. Only one VO bridge 730 may be used by default, or, all the I/O bridges 730 may be used simultaneously.

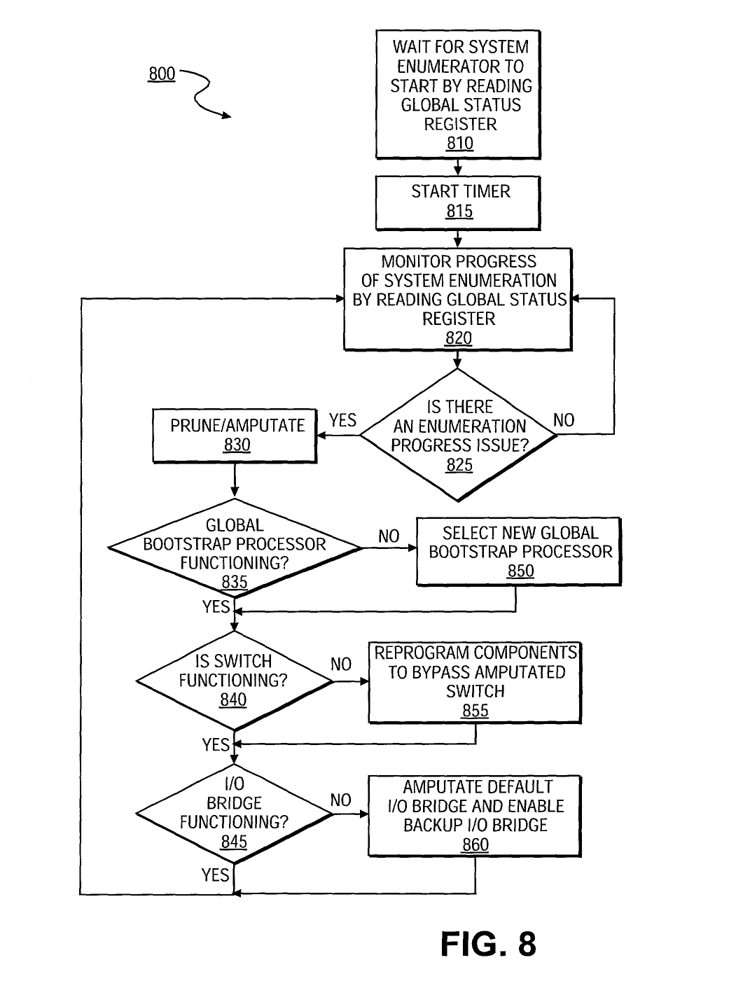

FIG. 8 illustrates a flow diagram of one embodiment for system component enumeration with server management 800. The SM device waits for system component enumeration to start (block 810). In one embodiment, the SM device determines that system enumeration has started by reading the global status register that may be written to by the global bootstrap processor. If system enumeration has begun, the SM device starts a timer (block 815). After starting the timer (block 815) the SM device monitors the progress of system component enumeration by reading the global status register (block 820). Based on the contents that are read from the global status register, the SM device determines if there is an enumeration progress issue (block 825). If there is no enumeration progress issue then the SM device continues to monitor progress of system component enumeration (block 820). If there is an enumeration progress issue, the SM device performs pruning and amputation (block 830). In one embodiment, information read from the global status register indicates which component of the system is malfunctioning. In another embodiment, the SM device determines that there may be an enumeration progress issue by evaluating how long an enumeration task is taking based on the timer and a predetermined time limit for the task.

After the SM device has pruned and/or amputated the malfunctioning device (block 830), the SM device determines if the global bootstrap processor is functioning (block 835). If the global bootstrap processor is not functioning properly, then a new global bootstrap processor is selected (block 850) and the old global bootstrap processor may be amputated. If the global boot strap processor is functioning, or, after selecting a new global boot strap processor (block 850), the SM device determines if the switches are functioning (block 840). In one embodiment, if any of the switches in the system are not functioning properly, the SM device may reprogram any switches that are functioning properly to handle all of the communication traffic (block 855) to bypass the malfunctioning switch, effectively amputating the malfunctioning switch. Next, the SM device determines if the default I/O bridge is functioning properly (block 845). If a default I/O bridge is not functioning properly, the default I/O bridge may be amputated and a back up bridge may be enabled (block 860). If the default bridge is functioning or the back up bridge has replaced the default bridge, then enumeration continues and the SM device continues to monitor the progress of system component enumeration (block 820).

It should be understood by one skilled in the art that a node may itself contain any number of elements which are themselves nodes, referred to as sub-nodes, and a hierarchical enumeration process that enumerates sub-nodes, followed by nodes, followed by system components is within the scope of the invention. Note that the system embodiments of FIG. 1A, FIG. 4, and FIG. 7 are nodes that include independent groups of system components equating to node elements that have similar functionality. These different embodiments may be part of a larger system. For example, the nodes 105 of FIG. 1A may include the system shown in FIG. 4 or FIG. 7. Therefore, the present invention applies to enumerating nodes within nodes, and may be used recursively.

It should also be understood by one skilled in the art that the SM device may be used to monitor enumeration progress of all elements or a portion of elements in a node. Likewise, the SM device may be used to monitor enumeration progress of all components or a portion of components in a system.

In alternate embodiments, the present invention may be implemented in discrete hardware or firmware. For example, the local and global boot flag registers may be implemented as a location in a memory device that is set to a specific value on power up, and changed after the first time the memory location is read by a processor.

In the foregoing description, the invention is described with reference to specific exemplary embodiments thereof. It will, however, be evident that various modifications and changes may be made thereto without departing from the broader spirit and scope of the present invention as set forth in the appended claims. The specification and drawings are to be regarded in an illustrative rather than a restrictive sense.

I claim:

1. A method comprising:
selecting a first portion of local node elements from a plurality of local node elements, wherein the plurality of local node elements are in an active state and are not enumerated;
de-activating a remaining portion of local node elements; and,
enumerating the plurality of local node elements with the selected first portion of local node elements.

2. The method of claim 1 wherein selecting the first portion includes selecting the portion which first accesses a device that is shared by the plurality of local node elements.

3. The method of claim 1 wherein selecting the first portion includes selecting the first portion of local node processor elements.

4. The method of claim 1 wherein de-activating the remaining portion includes putting the remaining portion into a hibernation state.

5. The method of claim 1 further comprising disabling a link interface between a local node and a larger system upon power up, wherein the larger system includes multiple nodes and the link interface allows information to be communicated between the local node and components of the larger system.

6. The method of claim 1 wherein enumerating the plurality of local node elements further includes:
determining if the plurality of local node elements are functional,
amputating the local node elements which are completely dysfunctional to disable the dysfunctional local node elements;
pruning the local node elements which are partially functional to disable only those parts of the partially functional local node elements which are dysfunctional and to enable those parts of the partially functional local node elements which are functional; and,
compiling a list of enumeration results to list the local resources in the node and the functionality of the local resources.

7. The method of claim 1 further comprising:
monitoring the enumeration progress of the plurality of local node elements;
selecting a second portion of local node elements from the plurality of local node elements if there is an enumeration progress issue;
enumerating the plurality of local node elements with the second portion of local node elements if there is an enumeration progress issue.

8. The method of claim 2 wherein selecting the portion which first accesses a device that is shared includes selecting the portion which first reads from a shared register.

9. The method of claim 5 further comprising enabling the link interface after enumerating the local node.

10. An apparatus comprising:
a node, wherein the node is a plurality of local node elements;
a first local bootstrap element to enumerate the plurality of local node elements, wherein the first local bootstrap element is one of the plurality of local node elements; and,
a shared local device to select which of the plurality of local node elements is the first local bootstrap element.

11. The apparatus of claim 10 wherein a node comprises a plurality of nodes and the nodes of the plurality of nodes include a first shared local device to select a first local bootstrap element and a first local bootstrap element to enumerate the plurality of local node elements.

12. The apparatus of claim 10 wherein the shared device is in a first logic state prior to the first access of the shared device and is in a distinct second logic state substantially immediately after the first access to the shared device.

13. The apparatus of claim 10 further comprising a server management device to monitor the progress of local node enumeration and to cause the selection of a second local bootstrap element from the plurality of local node elements and amputate the first local bootstrap element if the progress of local node enumeration does not meet a predetermined requirement.

14. The method of claim 10 wherein the local shared device is a register which has a first logic state prior to the first reading of the register by a local node element and a second logic state after the first reading of the register by a local node element.

15. The apparatus of claim 11 wherein the enumeration of the plurality of nodes is performed locally by the first local bootstrap elements substantially simultaneously.

16. The apparatus of claim 13 wherein the predetermined requirement is a time limit.

17. A computer-readable medium having stored thereon a sequence of instructions, the sequence of instructions including instructions which, when executed by a processor, causes the processor to perform:
selecting a first portion of local node elements from a plurality of local node elements, wherein the plurality of local node elements are in an active state and are not enumerated;
de-activating a remaining portion of local node elements; and,
enumerating the plurality of local node elements with the first portion.

18. The computer-readable medium of claim 17 further comprising instructions which, when executed by the processor, causes the processor to perform:
selecting the first portion as the portion which first accesses a device that is shared by the plurality of local node elements.

19. The computer-readable medium of claim 17 further comprising instructions which, when executed by the processor, causes the processor to perform:
enabling a link interface between a local node and a larger system, wherein the larger system includes multiple nodes and the link interface allows information to be communicated between the local node and components of the larger system.

20. An apparatus comprising:
a plurality of processor nodes wherein a processor node comprises a plurality of local elements;
a I/O bridge coupled to a plurality of I/O devices;
a switch to enable communication between the plurality of processor nodes and the plurality of I/O devices through the I/O bridge;
a plurality of node link interfaces to allow communications between the nodes and the switches, wherein the node link interfaces are disabled upon power up.
a plurality of first local bootstrap processors to enumerate the local elements of the processor nodes in the plurality of processor nodes, wherein the processor nodes include a first local bootstrap processor which is local to the nodes;
a plurality of local shared devices within the processor nodes to select the plurality of first local bootstrap processors, wherein the individual processor nodes include a local shared device which is local to the node;
a first global bootstrap processor to enumerate the components of the apparatus; and,
a global shared device accessible to the individual processor nodes to select the first global bootstrap processor.

21. The apparatus of claim 20 wherein the global shared device is coupled to the switch.

22. The apparatus of claim 20 wherein the global shared device is coupled to the I/O bridge.

23. The apparatus of claim 20 further comprising at least one server management device to monitor the progress of individual node enumeration and to cause the selection of a second local bootstrap processor from the plurality of local node elements and amputate the first local bootstrap processor for any node of the plurality of nodes in which the node enumeration is not completed within a predetermined time frame.

24. The apparatus of claim 20 further comprising at least one server management device to monitor the progress of system component enumeration and to cause the selection of a second global bootstrap processor from the plurality of system components and amputate the first global bootstrap processor if system enumeration is not completed within a predetermined time frame.

25. The apparatus of claim 20 wherein the plurality of local shared devices and the global shared device independently have a first logic state prior to the first access to the shared device and a distinct second logic state substantially immediately after the first access to the shared device.

26. The apparatus according to claim 20 wherein the plurality of first local bootstrap processors for the individual nodes of the plurality of nodes are selected substantially simultaneously and the plurality of first local bootstrap processors enumerate the plurality of local processor node elements substantially simultaneously.

27. The apparatus of claim 25 wherein the local shared devices and the global shared device are a register which has a first logic state of “0” prior to the first reading of the register by a processor element and a second logic state of not “0” substantially immediately after the first reading of the register by a processor element.

28. A computer system comprising:
a plurality of processors;
a local memory device to store BIOS instructions and enumeration results;
an interchip connection device to enable communication between devices in the computer system;
a boot flag register to select a bootstrap processor;
a bootstrap processor to enumerate devices in the computer system; and
a link interface to enable communication between the computer system and a switch.

29. The computer system of claim 28 wherein the link interface is disabled on power up and enabled after successful enumeration.

30. The computer system of claim 28 wherein the bootstrap processor is the first processor of the plurality of processors to read the boot flag register.
